(19) United States
(12) Patent Application Publication
(10) Pub. No.: US 2008/0060085 A1
(43) Pub. Date: Mar. 6, 2008

(54) Protecting Files on a Storage Device from Unauthorized Access or Copying

(76) Inventors: Jan Samzelius, San Francisco, CA (US); Tobias Karlsson, Haarlem (NL)

Correspondence Address: FISH & RICHARDSON P.C., PO BOX 1022, MINNEAPOLIS, MN, 55440-1022, US

(21) Appl. No.: 11/684,557

(22) Filed: Mar. 9, 2007

Related U.S. Application Data
(60) Provisional application No. 60/781,113, filed on Mar. 10, 2006.
(60) Provisional application No. 60/781,112, filed on Mar. 10, 2006.

(51) Int. Cl. H04L 9/28

(52) U.S. Cl. 726/30

(57) ABSTRACT

An electronic file can be decomposed into a number of fragments. The fragments can be randomly assembled into a number of fragment files, which can be stored randomly at different locations on one or more storage devices and/or on a network. One or more of the fragments and/or fragment files can be encrypted or otherwise protected. Instructions (e.g., fragment file locations, fragment assembly instructions) are generated for restoring the electronic file from the fragments. The instructions and other information (decryption keys) for restoring the electronic file can reside in a protected application. The protected application can intentionally be made inoperable until the protected application is dynamically linked at runtime with a security module obtained from, for example, a security service. Varying levels of protection (e.g., whether or not use a protected application) can be applied to electronic files based on file attributes.

### RELATED APPLICATIONS

The application claims the benefit of priority from U.S. Provisional Application No. 60/781,113, for “A System for Protecting Files Residing on a PC Hard Drive From Illegal Access or Copying by Anyone Other Than the Appropriate Owner/User of that PC,” filed Mar. 10, 2006, which provisional patent application is incorporated by reference herein in its entirety.

This application is related to U.S. Provisional Patent Application No. 60/781,112, for “A System for Protecting Attachments to Electronic Mail Messages (Emails) or Other Electronic File Transfer from Interception, Illegal Access or Copying or Being Obtained by any Person or Machine, Other than the Intended Recipient(s),” filed Mar. 10, 2006, which provisional patent application is incorporated by reference herein in its entirety.

This application is related to U.S. patent application Ser. No. 10/844,565, for “Anti-Piracy Software Protection System and Method,” filed May 11, 2004, which patent application is incorporated by reference herein in its entirety.

### TECHNICAL FIELD

The disclosed implementations relate generally to electronic file security.

### BACKGROUND

Personal computers and other electronic devices (e.g., mobile phones, personal digital assistants (PDAs), set-top boxes, email devices, game consoles, media players/recorders, etc.) typically include, or can be coupled to, one or more storage devices (e.g., hard drives, flash memory, optical drives, CD ROM, DVD, etc.) for storing electronic files (e.g., data, content, software programs). The electronic files can contain sensitive and/or confidential information, which if accessed or copied, can be used in identity theft or other crimes. The portability of storage devices have made electronic files even more vulnerable to theft or lost. Indeed, numerous news reports have reported thefts of laptops containing unprotected files with personal information, such as Social Security numbers, medical records, bank account information, etc.

Conventional solutions have focused on encrypting files on the storage device and enforcing strict policies on employees regarding the removal of sensitive information from the workplace. Unfortunately, employees do not always follow company policies and many encryption algorithms can be broken in a matter of days by computer hackers.

### SUMMARY

An electronic file can be decomposed into a number of fragments. The fragments can be randomly assembled into a number of fragment files, which can be stored randomly at different locations on one or more storage devices and/or on a network. One or more of the fragments and/or fragment files can be encrypted or otherwise protected. Instructions (e.g., fragment file locations, fragment assembly instructions) are generated for restoring the electronic file from the fragments. The instructions and other information (decryption keys) for restoring the electronic file can reside in a protected application. The protected application can intentionally be made inoperable until the protected application is dynamically linked at runtime with a security module. Different levels of protection (e.g., whether or not use a protected application) can be applied to electronic files based on file attributes.

In some implementations, a method of protecting electronic files residing on a storage device includes: decomposing a source file into fragments; randomly assembling the fragments into fragment files; storing the fragment files at different locations on the storage device; and creating instructions for restoring the source file from the fragments.

In some implementations, a method of restoring a file residing on a storage device includes: receiving a request to launch a protected application, the protected application including partial instructions for restoring a source file from fragments stored in fragment files on the storage device; and responsive to the request, establishing a dynamic link between the protected application and a security module configured for providing a missing instruction for restoring the source file.

Other implementations are disclosed that are related to systems, methods and computer-readable mediums.

### DESCRIPTION OF DRAWINGS

FIG. 1 is a block diagram showing an example of a system for protecting and restoring a file residing on a storage device.

FIG. 2 is a flow diagram showing an example of a process for protecting a file residing on a storage device.

FIG. 3 is a flow diagram showing an example of a process for restoring a file residing on a storage device.

FIG. 4 is a schematic diagram showing an example of a generic device architecture for implementing the processes shown in FIGS. 2 and 3.

### DETAILED DESCRIPTION

### File Decomposition

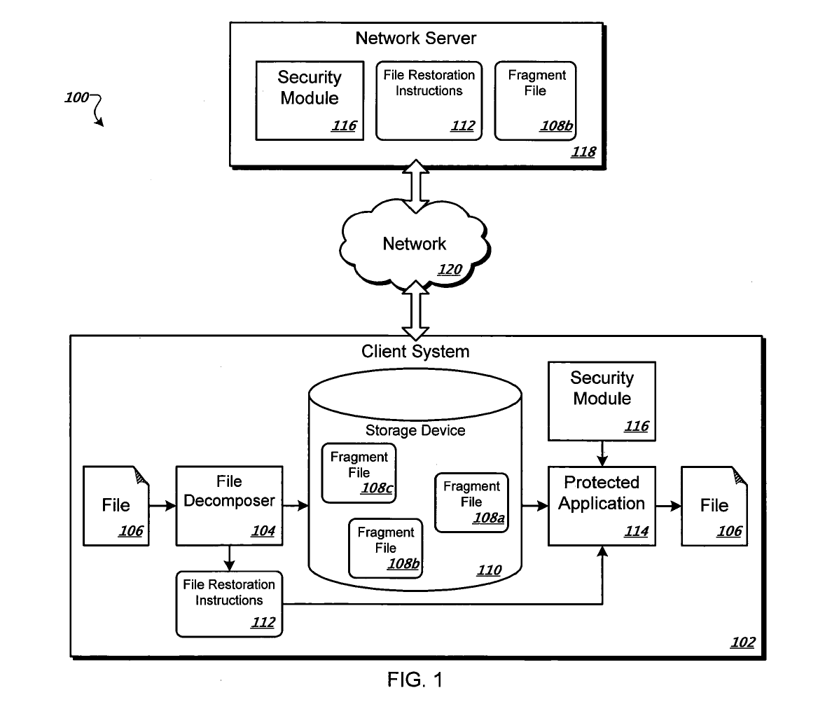

FIG. 1 is a block diagram showing an example of a system 100 for protecting and restoring a file residing on a storage device 110. In some implementations, the system 100 includes a client system 102 where a user may store and retrieve files, such as word processing documents, spreadsheets, or applications. The system 100 protects files by decomposing the files into a number of fragments, assembling the fragments into fragment files and storing the fragment files at different locations on a storage device 110, such as, for example, an internal hard drive, removable storage (e.g., USB flash drive, external drive) or any other media capable of storing files.

In the example shown, a file decomposer 104 decomposes an electronic file 106 into a number of fragments and assembles the fragments into a number of fragment files 108a-c. In some implementations, the file decomposer 104 can randomly (e.g., pseudo randomly) assemble the fragments into fragment files 108a-c to provide additional protection. Alternatively, the fragments can be assembled into fragment files 108a-c based on a predefined assembly scheme. The amount of data in each of the fragments may be small, such as one byte or character of information per fragment. The client system 102 stores the fragment files 108a-c at different locations on a storage device 110. The file decomposer 104 also creates file restoration instructions 112 (e.g., fragment reassembly instructions, locations of fragment files, etc.) for restoring the source file 106 from the fragments in fragment files 108a-c.

In some implementations, the fragment files 108a-c may be stored at random or unrelated locations on the storage device 110. In some implementations, one or more of the file fragments 108a-c may be encrypted using known private-key (e.g., DES, AES) or public-key (e.g., RSA) encryption techniques. In some implementations, each of the file fragments 108a-c can be associated with an identifier. The file restoration instructions 112 can use the identifiers to distinguish one file fragment from another when restoring fragments into the source file 106.

### File Restoration

In some implementations, a protected application 114 uses the instructions 112 for restoring the file fragments 108a-c into the source file 106, for example, at the request of a user or an application accessing the file 106. The protected application 114 can include, or has access to, a portion of the file restoration instructions 112. Because the protected application 114 has access only to a portion of the instructions 112, the protected application 114 is inoperable for restoring the source file 106 without the missing portion of instructions. This feature allows the protected application to be freely or virally distributed to end users who then must obtain the missing portion of instructions before the source file 106 can be restored by the protected application 114. The protected application 114 can be any application capable of reading a document, including but not limited to: a document reader (e.g., Adobe Acrobat®), a software application (e.g., word processor, email application, IM application, spread sheet, media player, etc.), a plug-in, etc. In some implementations, the functionality of the protected application can be integrated into an operating system or server (e.g., Microsoft® Windows XP, Palm® OS, Linux® OS).

In some implementations, the protected application 114 is configured to establish a dynamic link to a security module 116 (e.g., a dynamic link library or DLL) during, for example, runtime of the protected application 114. The security module 116 provides the missing portion of the file restoration instructions 112 to the protected application 114. For example, the missing portion of the file restoration instructions 112 may be a pointer to a function within program code of the protected application 114. Alternatively or in addition, the missing portion of the file restoration instructions 112 may include a unique data string, such as an encryption key. The protected application 114 then uses the function pointer and/or the unique data string to restore the file 106.

In some implementations, one or more of the security module 116, the file restoration instructions 112, and one or more file fragments, such as the fragment file 108b may be stored separately from the storage device 110. For example, the client system 102 may be in communication with a network server 118 through a network 120 (e.g., the Internet, intranet, wireless network). The file decomposer 104 can store some or all of the file restoration instructions 112 and/or the fragment file 108b at the network server 118. The network server 118 can provide one or more of the security module 116, the file restoration instructions 112, and the file fragment 108b to the client system 102.

In some implementations, the file decomposer 104 embeds the file restoration instructions 112, or a portion thereof, in the protected application 114. The file decomposer 104 can prevent restoration of the file 106 by disabling the protected application 114. The file decomposer 104 can disable the protected application 114 by changing program code of the protected application 114, such as by removing a portion of program code and/or by replacing a portion of program code with random code. For example, if the protected application 114 is reverse compiled or decompiled, the results may include missing; or random portions of program code. The protected application 114 establishes a dynamic link with the security module 116 to retrieve the missing portion of the file restoration instructions 112 and enable the protection application 114 to restore the source file 106.

In some implementations, access to the security module 116 is protected by authenticating the identity of the user. For example, the user may be required to provide a username and password before the security module 116 may be accessed. Alternatively or in addition, the user may be required to provide an identifier provided by a secure identifier generator device or the user may be required to provide biometric identification information. In some implementations, the network server 118 may provide authenticated access to the security module 116 as described above. For example, the user may browse to a web page presented by the network server 118 where the user may input identification information and then retrieve the security module 116.

In some implementations, an administrative user may designate particular types of protection for particular files. For example, a first level of protection for a first file may encrypt all file fragments and store at least one file fragment at the network server 118. A second level of protection for a second file may encrypt one fragment and store no fragments at the network server 118. The protection level may be based on, for example, a file attribute (e.g., a file type as determined by the file name extension), content of the file, or metadata associated with the file.

### File Decomposition and Restoration Processes

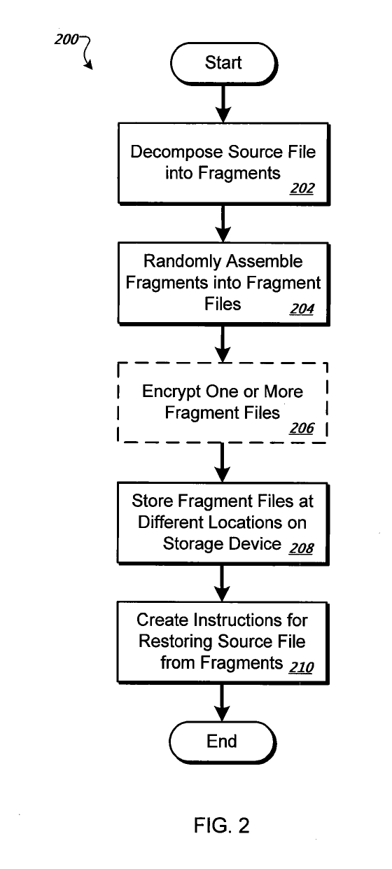

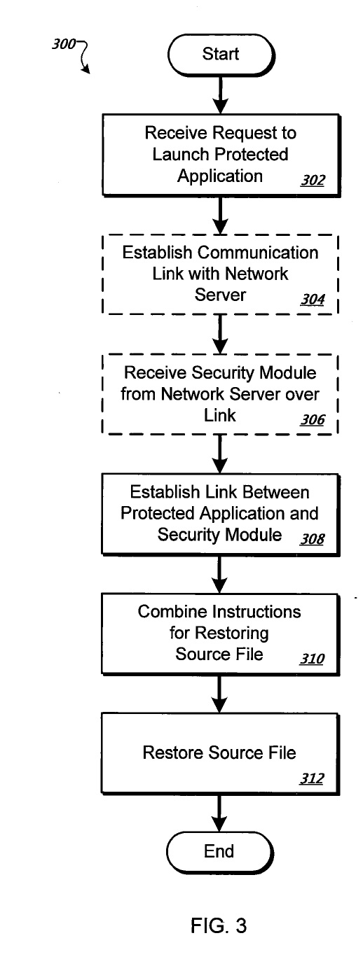

FIGS. 2 and 3 are flow diagrams showing examples of processes 200 and 300 for protecting and restoring an electronic file residing on a storage device, respectively. The processes 200 and 300 may be performed, for example, by a system such as the system 100. For clarity of presentation, the description that follows uses the system 100 as the basis of an example for describing the processes 200 and 300. However, another system, or combination of systems, may be used to perform the processes 200 and 300. The processes 200 and 300 can be performed sequentially by a single processor or in parallel using a multi-processor or multi-processor core system.

Referring now to FIG. 2, the process 200 begins with decomposing (202) a source file 106 into a number of fragments. The fragments can be any desired size, including a single byte or character per fragment. In some implementations, each fragment can be associated with an identifier (e.g., an integer value) and a map can be constructed using the identifiers for describing how the fragments fit together. For example, the file decomposer 104 may decompose the source file 106 into a number of fragments of uniform or non-uniform size, such as one byte portions. Each fragment can then be numbered consecutively from the beginning to the end of the source file 106. Other fragment numbering or identifying schemes are possible, including using a known hash function or message digest to generate a unique fingerprint for each fragment.

The process 200 assembles (204) (e.g., randomly) the fragments into fragment files 108a-c. Optionally, the process 200 can encrypt (206) one or more of the fragment files 108a-c using a known encryption algorithm. In some implementations, fragments from different source files can be assembled in the same fragment file. In some implementations, one or more fragments can be periodically swapped between two or more fragment files 108a-c based on a schedule or in response to a trigger event (e.g., the removal of the storage device from a facility, unplugging the device from a docking station or outlet power). For example, the fragment swapping can be scheduled to occur periodically based on a timer in the device (e.g., a CPU clock, watchdog timer).

In some implementations, the process 200 stores (208) the fragment files at different locations on a storage device. For example, the file decomposer 104 may store the fragment files 108a-c in the storage device 110. In some implementations, the fragment files 108a-c are stored at random locations on the storage device 110. A native file system or operating system of the device can be used to store the files in various locations. Additionally, the file decomposer 104 may store one or more of the fragment files 108a-c at the network server 118, as described in reference to FIG. 1. In some implementations, the fragment files 108a-c can be stored on multiple storage devices and/or distributed over one or more networks.

The process 200 creates (210) instructions for restoring the source file from the fragment files. For example, the file decomposer 104 can create file restoration instructions 112. The file decomposer 104 can embed a portion of the file restoration instructions 112 in the protected application 114. Another portion of the file restoration instructions 112, such as a pointer to a function within the protected application 114 and/or an encryption key for decrypting one or more of the fragment files 108a-c, may be included in the security module 116. The security module 116 may also be stored at the network server 118. In some implementations, access to the security module is provided only after the user has been authenticated and subject to a desired number of security procedures.

FIG. 3 is a flow chart showing an example of the process 300 for restoring a file residing on a storage device. The process 300 begins with receiving (302) a request to launch a protected application. For example, the client system 102 may receive a request from a user to access the file 106 that launches the protected application 114. The protected application 114 includes a portion of the file restoration instructions 112.

Optionally, the process 300 establishes (304) a communication link with a network server. For example, the protected application 114 may establish a communication link with the network server 118 through the network 120.

Optionally, the process 300 receives (306) a security module from the network server. For example, the client system 102 may receive the security module 116 from the network server 118. The network server 118 may protect access to the security module 116 by authenticating the user requesting the security module 116, such as by verifying user identification information.

In some implementations, the process 300 establishes (308) a dynamic link between the protected application and the security module. For example, the protected application 114 may establish a dynamic link between itself and the security module 116. The security module 116 may be a program module, such as a DLL or a shared object library. The protected application 114 may access functions provided by the security module 116 at runtime.

In some implementations, an anti-piracy software protection system and method can be used, as described in, for example, U.S. patent application Ser. No. 10/844,565, for “Anti-Piracy Software Protection System and Method.”

In some implementations, the process 300 combines (310) partial instructions for restoring the source file from the protected application and missing instructions for restoring the source file from the security module. For example, the protected application 114 combines its portion of the file restoration instructions with the portion from the security module 116. The security module 116 may provide a missing portion of the file restoration instructions 112, such as a pointer to a function within the protected application 114 and/or an encryption key. The encryption key may be used to decrypt one or more of the fragment files 108a-c. The function pointer may be used to call program code that restores the source file 106 from the fragment files 108a-c.

In some implementations, the process 300 restores (312) the source file using the combined instructions for restoring the source file. For example, the protected application 114 may restore the source file 106 using the file restoration instructions 112, such as by decrypting one or more of the fragment files 108a-c and assembling the fragment files 108a-c using a function in the protected application 114 identified by a function pointer in the security module 116.

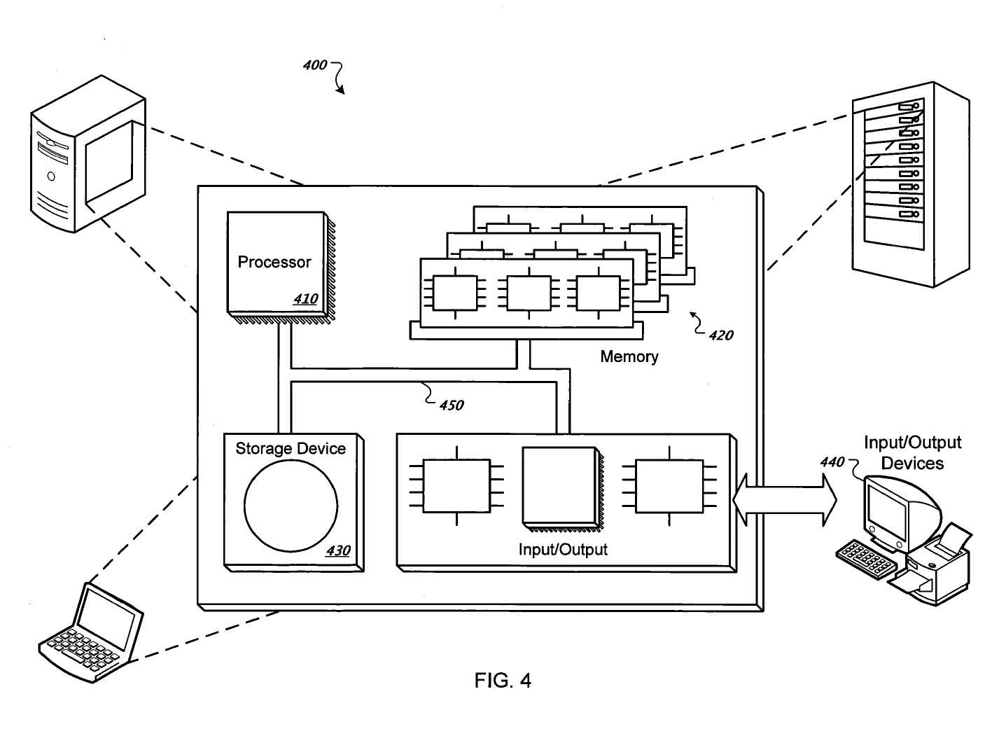

FIG. 4 is a schematic diagram showing an example of a generic computer system 400 for implementing the processes 200 and 300 shown in FIGS. 2 and 3. The system 400 can be used for the operations described in association with the processes 400 and 500 according to one implementation. For example, the system 400 may be included in either or all of the client system 102 and the network server 118.

The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In some implementations, the processor 410 is a single-threaded processor. In other implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described above can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or processor cores of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method of protecting electronic files residing on a storage device, comprising:
decomposing a source file into fragments;
randomly assembling the fragments into fragment files;
storing the fragment files at different locations on the storage device; and
creating instructions for restoring the source file from the fragments.

2. The method of claim 1, wherein storing the fragment files further comprises:
randomly storing the fragment files at different locations on the storage device.

3. The method of claim 1, further comprising:
encrypting one or more of the fragment files.

4. The method of claim 1, further comprising:
embedding the instructions in a protected application operable for restoring the source file from the fragments using the instructions.

5. The method of claim 4, further comprising:
disabling the protected application by changing a portion of the application's program code.

6. The method of claim 5, wherein changing a portion of the application's program code further comprises:
removing a portion of the application's program code.

7. The method of claim 5, wherein changing a portion of the application's program code further comprises:
replacing a portion of the application's program code with random code.

8. The method of claim 1, further comprising:
storing one or more fragment files on a network server.

9. A method of restoring a file residing on a storage device, comprising:
receiving a request to launch a protected application, the protected application including partial instructions for restoring a source file from fragments stored in fragment files on the storage device; and
responsive to the request, establishing a dynamic link between the protected application and a security module configured for providing a missing instruction for restoring the source file.

10. The method of claim 9, further comprising:
establishing communication link with a network server; and
receiving the security module from the network server over the link.

11. The method of claim 9, wherein the missing instruction is a function pointer.

12. The method of claim 9, wherein the missing instruction is a unique data string.

13. A system of protecting files residing on a storage device, comprising:
a processor;
a computer-readable medium operatively coupled to the processor and including instructions, which, when executed by the processor, causes the processor to perform the operations comprising:
decomposing a source file into fragments;
randomly assembling the fragments into fragment files;
storing the fragment files at different locations on the storage device; and
creating instructions for restoring the source file from the fragments.

14. The system of claim 13, wherein storing the fragment files further comprises:
randomly storing the fragment files at different locations on the storage device.

15. The system of claim 13, further comprising:
encrypting one or more of the fragment files.

16. The system of claim 13, further comprising:
embedding the instructions in a protected application operable for restoring the source file from the fragments using the instructions.

17. The system of claim 16, further comprising:
disabling the protected application by changing a portion of the application's program code.

18. The system of claim 17, wherein changing a portion of the application's program code further comprises:
removing a portion of the application's program code.

19. The system of claim 17, wherein changing a portion of the application's program code further comprises:
replacing a portion of the application's program code with random code.

20. The system of claim 13, further comprising:
storing one or more fragment files on a network server.

21. A computer-readable medium having instructions stored thereon, which, when executed by a processor, causes the processor to perform operations comprising:
decomposing a source file into fragments;
randomly assembling the fragments into fragment files;
storing the fragment files at different locations on the storage device; and
creating instructions for restoring the source file from the fragments.

22. A system for restoring a file residing on a storage device, comprising:
a processor;
a computer-readable medium operatively coupled to the processor and including instructions, which, when executed by the processor, causes the processor to perform operations comprising:
receiving a request to launch a protected application, the protected application including partial instructions for restoring a source file from fragments stored in fragment files on the storage device; and
responsive to the request, establishing a dynamic link between the protected application and a security module configured for providing a missing instruction for restoring the source file.

23. The system of claim 22, further comprising:
receiving the security module over a network connection.

24. The system of claim 22, wherein the missing instruction is a function pointer.

25. The system of claim 22, wherein the missing instruction is a unique data string.

26. A computer-readable medium having instructions stored thereon, which, when executed by a processor, causes the processor to perform operations comprising:
receiving a request to launch a protected application, the protected application including partial instructions for restoring a source file from fragments stored in fragment files on the storage device; and
responsive to the request, establishing a dynamic link between the protected application and a security module configured for providing a missing instruction for restoring the source file.

27. A system for protecting electronic files residing on a storage device, comprising:
means for decomposing a source file into fragments;
means for randomly assembling the fragments into fragment files;
means for storing the fragment files at different locations on the storage device; and
means for creating instructions for restoring the source file from the fragments.
